(19) United States
(12) Patent Application Publication
(10) Pub. No.: US 2020/0247543 A1
(43) Pub. Date: Aug. 6, 2020

(54) SURFACE PROTECTION SYSTEMS AND METHODS OF USE

(71) Applicant: Eric W. Buller, Washougal, WA (US)

(72) Inventor: Eric W. Buller, Washougal, WA (US)

(21) Appl. No.: 16/777,759

(22) Filed: Jan. 30, 2020

Related U.S. Application Data
(60) Provisional application No. 62/799,626, filed on Jan. 31, 2019.

(51) Int. Cl. B64D 11/00; B64C 1/18; B32B 9/04; B32B 7/06

(52) U.S. Cl. CPC B64D 11/00; B64C 1/18; B32B 5/06; B32B 7/06; B32B 2307/7265; B32B 9/047

(57) ABSTRACT

Surface protection systems can be applied when the protection of flooring surfaces from contaminates is desired or required to maintain their integrity and appearance. Surface protection systems can be highly storable when rolled up and held together with, for example, integrated straps. When needed, it can be unrolled and placed onto aircraft flooring (or other surfaces) to provide a waterproof, absorbent, slip resistant and adjustable barrier.

### CROSS REFERENCE TO RELATED APPLICATION

This application claims the benefit of U.S. Provisional Patent Application No. 62/799,626, filed Jan. 31, 2019. U.S. Provisional Patent Application No. 62/799,626 is incorporated herein by reference in its entirety.

### FIELD

This disclosure relates generally to the protection of surfaces from contaminates, such as during maintenance, inclement weather or to prevent unnecessary wear and tear on flooring and other surfaces.

### BACKGROUND

Vehicle flooring, such as carpeted surfaces in aircraft, are subject to a variety of contaminates such as dirt, small rocks, tar, fuel and glycol. Environmental contaminates such as rain, snow and dust also can become a factor in the longevity and appearance of those carpets and flooring. Without protection; dirt, small rocks and dust from paved surfaces can start to break down the fibers at the base of carpet and eventually cause the carpet fibers to separate. At the same time smaller particulates and manmade materials such as tar, fuel and de-icing glycol can stain the carpeted surface and degrade the appearance of the flooring. Over time the carpet will develop stains that cannot be removed and will eventually require the removal and replacement of the carpets which are expensive and custom made for most aircraft.

The protection of many different types of surfaces, such as carpeted aircraft flooring, is of important aesthetic, financial, and/or functional importance. Accordingly, systems and methods for providing improved surface protection are desirable.

### BRIEF DESCRIPTION OF THE DRAWINGS

FIG. 1 shows the top of a surface protection system when laid out flat.

FIG. 2 shows the bottom of a surface protection system when laid out flat.

FIG. 3 shows a surface protection system in a state of partial roll and unsecured by the straps.

FIG. 4 shows a surface protection system rolled and secured with the straps holding it tightly together for storage.

FIG. 5 shows the topside of the entryway flap.

FIG. 6 shows the bottom of the entryway flap.

FIG. 7 shows a side profile view of how the surface protection system entryway flap attaches to a main piece using hook and loop fasteners in an aircraft with a step down to the aisleway where the main piece is on the aircraft floor in this particular illustration of use.

FIG. 8 shows the top stitch method of attaching the top and bottom pieces of the surface protection system together and creates a finished edge.

FIG. 9 illustrates an exemplary use of a surface protection system of the type described herein.

### SUMMARY

The surface protection systems and methods described herein can be applied when the protection of flooring surfaces from contaminates is desired or required to maintain their integrity and appearance.

In some embodiments, the surface protection system can be highly storable when rolled up and held together with, for example, integrated straps. When needed, it can be unrolled and placed onto the aircraft flooring (or other surfaces) to provide a waterproof, absorbent, slip resistant and adjustable barrier.

Preferably, it can be cleaned using traditional laundering methods to remove soiling. It accomplishes this by using an absorbent top layer that is stitched to a waterproof and a slip resistant bottom layer. The width and length can be selected based on the desired use, such as a corresponding width and length of an aircraft model that is to be protected.

In some embodiments, an adjustable flap made of the same materials and construction can be provided to cover an area that extends away from the main body of the surface protection system, such as an entryway of an aircraft. In this manner, complete protection for the flooring can be provided over the surfaces that require access by maintenance personnel and the like.

In some embodiments, the flap can attach to the main piece using hook and loop style fasteners and can be adjusted fore and aft along the length of the main piece to accommodate the differing positions of the entryway on different models of aircraft.

In some embodiments, the main piece can be held in place using hook style fastening strips or other non-slip fastener located on the bottom surface of the surface protection system that prevent movement of the surface protection system while in place. Use of these fastener styles on carpeted surfaces also allows for the easy removal of the surface protection system when not in use while maintaining the integrity of the carpet below. When not in use, it can be easily rolled into its self and held together with the attached straps for storage.

### DETAILED DESCRIPTION

General Considerations

The systems and methods described herein, and individual components thereof, should not be construed as being limited to the particular uses or systems described herein in any way. Instead, this disclosure is directed toward all novel and non-obvious features and aspects of the various disclosed embodiments of surface protection systems and the components thereof, alone and in various combinations and subcombinations with one another.

For example, any features or aspects of the disclosed embodiments can be used in various combinations and subcombinations with one another, as will be recognized by an ordinarily skilled artisan in the relevant field(s) in view of the information disclosed herein. In addition, the disclosed systems, methods, and components thereof are not limited to any specific aspect or feature or combinations thereof, nor do the disclosed things and methods require that any one or more specific advantages be present or problems be solved.

As used in this application the singular forms “a,” “an,” and “the” include the plural forms unless the context clearly dictates otherwise. Additionally, the term “includes” means “comprises.” Furthermore, as used herein, the term “and/or” means any one item or combination of items in the phrase.

As used herein, the term “exemplary” means serving as a non-limiting example, instance, or illustration. As used herein, the terms “e.g.,” and “for example,” introduce a list of one or more non-limiting embodiments, examples, instances, and/or illustrations.

The systems and methods described herein relate to surface protection systems, with the primary embodiment disclosed relating to protecting aircraft interiors. However, one of ordinary skill in the art will understand that such systems can be used to protect other surfaces.

Aircraft Interiors and Other Surfaces Requiring Protection

Carpeted aircraft interiors can include removable carpet mats that are made from either the same carpet as installed in the rest of the aircraft or sections of vinyl. These mats take the brunt of the wear and contaminates from outside the aircraft. Typically, they are also custom made, expensive and when not installed in the aircraft provide no protection to the underlying carpeted surfaces. Longer full-length carpet runners are also incorporated into some aircraft; however, it then becomes a matter of a larger piece of carpet to clean and eventually replace once worn out. Such systems are also often easily stained and scratched, and can be slippery when wet, difficult to remove and again will provide no protection when not installed in the aircraft. There can also be the loss of aesthetics when they are installed. Some aircraft incorporate vinyl like flooring in the entryway and galley areas of the aircraft to make floor cleaning easier however they are still prone to the manmade and environmental damage described above.

Aircraft require a lot of preventative maintenance and repairs due to their complexity and requirements by the manufacturer and governing authorities. This maintenance is typically performed by an aircraft repair facility. While the aircraft is being serviced; maintenance personnel enter and exit the aircraft repeatedly to perform various functions of the inspections and repairs. Shop floor contaminates such as fuel, hydraulic fluid, dirt and metal shavings can easily find their way into the aircraft and onto the flooring. Since the primary goal is to complete the repairs on a schedule, sometimes interior protection is a secondary thought. Even when protection is considered, the current choices for such facilities is limited. Plastic sheeting, shop towels and old carpet protection runners are often used but is entirely up to the facility and its policies on how and when it should be used. This leaves the owner or operator at the mercy of the facility or individual performing the work. Plastic sheeting is a disposable option that works well but is only used once and typically only used in a small are around the entryway. It can also cause contaminates such as liquid to transfer to the unprotected surfaces while in use or when being taken back up. Shop towels can transfer fibers, contaminates and liquid directly onto the protected surfaces. Old carpet runners from other aircraft either made of carpet or more typically vinyl can be of disproportionate size, leave contaminates from a lack of ability to effectively clean them and can cause a tripping hazard to personnel working on the aircraft.

While in a maintenance environment it is common that the aircraft should need to be put outside for temporary storage or for completing maintenance tasks that involve the operation of the aircraft systems that cannot be completed indoors. When the aircraft is outside it is subject to both manmade and environmental contaminations as described above. Dirty water from rain and snow can enter the aircraft and be deposited onto the interior flooring surfaces. Again, protection of these surfaces is paramount and the current offerings for protection are lacking in their effective performance.

During regular use of the aircraft, the carpeted surfaces are subject to the contamination as described above. Crew members must routinely enter and exit the aircraft to prepare for flight and can inadvertently cause contaminates to enter the aircraft and cause damage to unprotected flooring. Passengers boarding the aircraft during inclement weather will also do damage while entering the aircraft. Without protection in place the result is the same. Degradation and damage can occur to the flooring installed in the aircraft.

Other applications where protection of the aircraft surfaces is needed include during maintenance activities and regular cleaning of the aircraft exterior. Often personnel must climb onto the wings, engines or other surfaces to complete the tasks required. Solutions currently available offer protection, but are either insufficient, such as shop towels that can slide or are bulky foam which can be hard to maneuver and store. Again, the ability to have the protection on-hand and have the ability clean it once soiled solves many issues associated with damage. The protection currently being used to prevent contamination to the underlying surface from rock, metal and other foreign materials is lacking. Allowing such contaminates to come in contact with the surfaces can produce scratches and blemishes to the exterior of the aircraft.

Surface protection as described above can be used in any situation where protection of the underlying surfaces is of utmost importance and not limited to simply aircraft or the aviation industries. In automotive repair and restoration, protection is important to the finish and value of the vehicle being worked on. Having waterproof, absorbent, non-slip and washable protection in place can save the repair facility or end user from costly cosmetic repairs.

Applications in the marine, recreational vehicle and high-end flooring can also benefit from the protections listed above. What is needed is protection that is easily deployable, fits properly to the application it is being used for, offers protection from all contaminates including liquids and solids by its being waterproof and absorbent, is resistant to slipping, can be easily removed and stored in a limited space and can be cleaned using common laundering techniques. This surface protection system allows the performing facility or end user to provide reliable, reusable and cleanable protection in a manner that suits the needs of the tasks at hand while maintaining the integrity of the surfaces being protected. In vehicles this surface protection system can also give the owner or operator an effective way to protect surfaces when maintenance personnel or facilities are unable to provide their own forms of protection.

Exemplary Surface Protection Systems

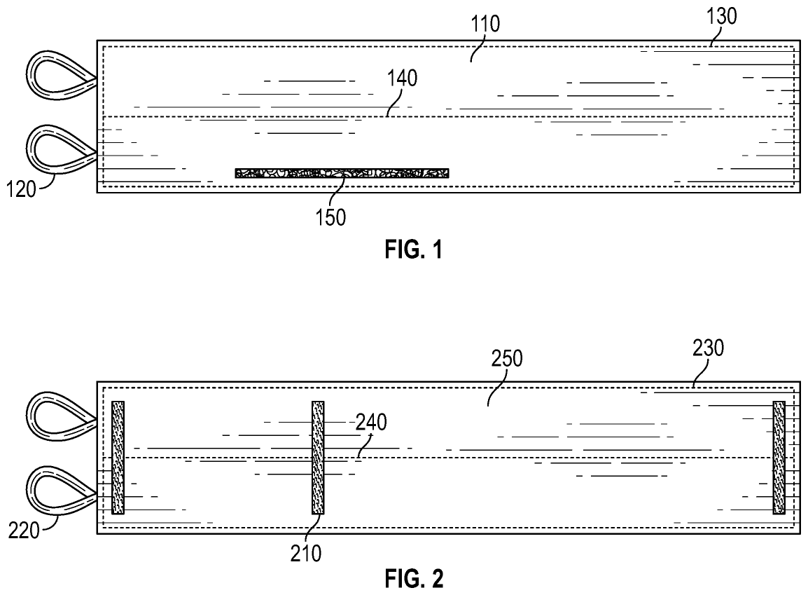

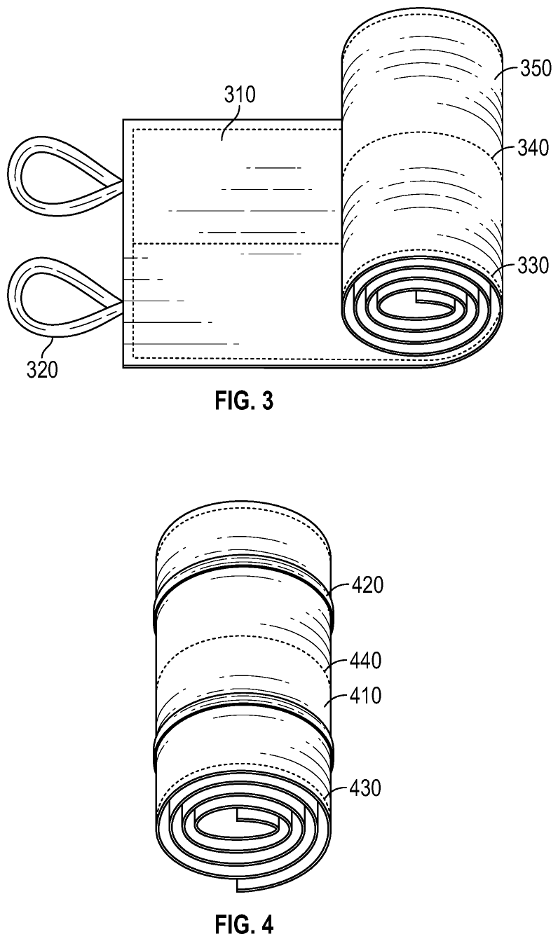

FIG. 1 illustrates a top view of an exemplary surface protection system that comprises a top layer and a bottom layer, and FIG. 2 illustrates a bottom view of the surface protection system.

The top layer of the surface protection system consists of an absorbent type of fabric. In a preferred embodiment, the top layer comprises a thick cotton canvas (110, 310, 510, 740, 780 and 810). This type of canvas is strong, wear resistant and can be laundered. Preferably the top layer is selected from fabrics, such as the thick cotton canvas, that can absorb and disperse liquids throughout its matrix which will prevent pooling of liquids that may in turn run off and damage the surface to be protected. In some embodiments, the material of the top layer can comprise a 10 oz. canvas or denim material.

An exemplary configuration showing this top layer is illustrated in FIG. 1. This top layer can comprise a receiving area for receiving a member that can extend from a main body of the top layer. For example, a length of loop style fastener (150) can be applied to the top surface. The loop style fastener can be configured to receive an adjustable entryway flap when desired for additional surface protection. Other fasteners are possible, so long as they are capable of securing, at least temporarily, the extending member during use. For example, clips, buttons, adhesives, or other such coupling members could be provided in place of the loop style fastener.

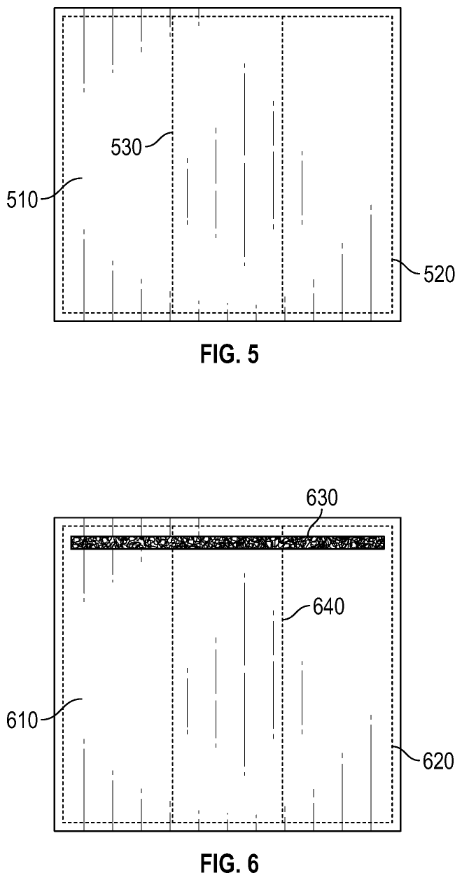

An example of an extending member (e.g., a flap) is shown in FIG. 5 and FIG. 6. The loops 630 which are used to hold the surface protection system together when rolled are included in examples 120, 220 320 and 420 and are sewn between the top and bottom layers.

As discussed below, the top layer can be coupled to a bottom layer of different material. In the illustrated embodiment the top layer is secured to the bottom layer by stitching (130, 230, 330, 430, 520 and 620).

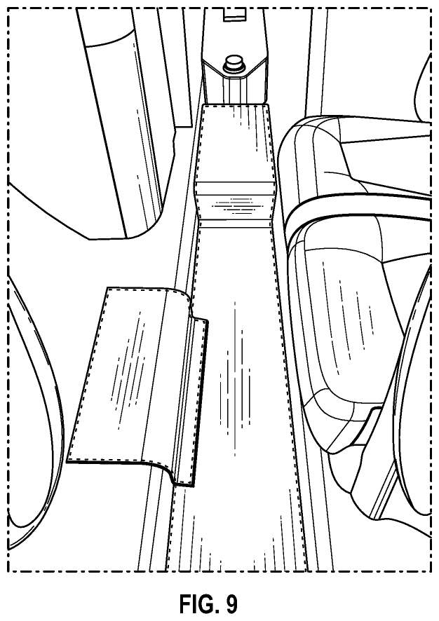

The top layer and the bottom layer can be held together using the method of top stitching as illustrated in FIG. 8. Except for one end being a straight stitch, this stitch provides a strong, simple and finished method for adhering the top and bottom layers together. An optional method to prevent the top layer and bottom layer from sliding against each other in the center can be a simple straight stitch as shown in examples (140, 240, 340, 440, 530 and 640) running the length of the material and adhering the top and bottoms layers together.

The bottom layer (250, 350, 410, 610, 750, 790 and 820) of the surface protection system preferably comprises a waterproof textile that provides a slip resistant quality. In some embodiments, the bottom layer comprises textured vinyl fabric. The material is preferably lightweight, semi-flexible to flexible and can be laundered by traditional methods. An exemplary configuration showing this bottom layer is illustrated in FIG. 2. The bottom layer is adhered to the top layer as described above. The bottom layer can include one or more securing members to prevent and/or restrict movement of the surface protection system during use. For example, as shown in FIG. 2, the bottom layer can include one or more fasteners, such as the hook portion of the hook and loop style fastener, which are sewn into the bottom layer which provide a method to prevent movement of the surface protection system on the carpeted surfaces. An example of the placement for those fasteners is indicated by (210) in FIG. 2. The placement of these fasteners can vary depending on the intended use (e.g., the aircraft model to be fitted).

One or more extending members can be provided to allow for coverage that extends away from the main body of the surface protection system. The extending member, such as an entryway flap, can be made from the same materials as mentioned above. An exemplary configuration showing this bottom layer is illustrated in FIG. 5 and FIG. 6. This entryway flap can be made to varying sizes in order to facilitate different aircraft models. The flap can have on the bottom layer a strip of hook style fastener, which can be used to attach it to the main body of the surface protection system when needed or to adjust its position fore and aft for different aircraft models. Preferably the strip of material 150 on the top layer is longer than a width of a corresponding strip of material on the extending member (e.g., flap) to permit a user to vary the location of the flap in use. In some embodiments, the strip of material 150 on the top layer is at least 150% longer than the width of a corresponding strip of material 630 on the extending member, in other embodiments it is between 150% and 300% longer, or between 200% and 250% longer.

The extending member (e.g., flap) can also include a fastener on the lower surface, as described with respect to the main body, to temporarily adhere a lower surface of the flap to a carpeted entryway.

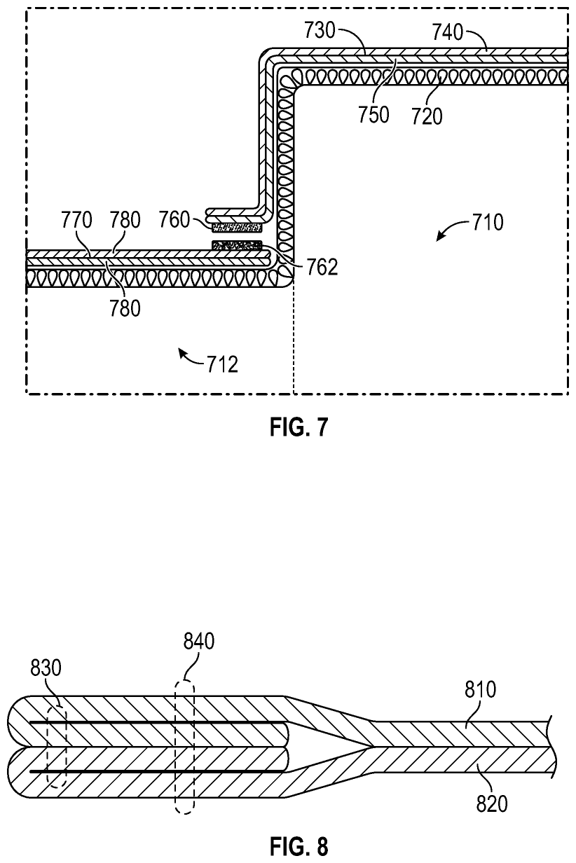

The extending member can be easily removed from the main body to allow for repositioning or so that it can be laundered separately from the main piece. An exemplary configuration showing this entryway flap in practical use on an aircraft with a step down into the aisleway is shown in FIG. 7 and FIG. 9. In FIG. 7, the main piece (770) rests on the carpeted aisleway floor (712 and 720). The entryway flap (730) rests on the carpeted raised floor (710 and 720) of the illustrated aircraft. The illustration also shows how the hook (760) and loop (762) are mated together to create seamless protection from the entryway into and onto the main piece in the aisleway. FIG. 9 illustrates a surface protection system in use on an aircraft, with an extending member (flap) extending away from the main body to protect a raised entry surface.

In some embodiments, a length of the main body of the surface protection system is between 108 inches and 230 inches and a width of the main body is between 12 inches and 36 inches. A length of the extending member of the surface protection system (measured perpendicularly to the length of the main body) can be between 14 inches and 24 inches, and a width of the main body is between 20 inches and 28 inches. Thus, in some embodiments, the length of the main body can between 5 and 16 times greater than the length of the extending member.

Use of the surface protection system for surface protection as described above creates a durable and reusable option for the protection of aircraft interiors.

This surface protection system can be utilized by aircraft maintenance providers to ensure that there are no adverse effects to the interior flooring from the tasks they are required to complete as part of routine or preventative maintenance. The surface protection system can be made to suit a generic aircraft design that will allow its use in many aircraft models, thus saving money without the need to purchase model select protection. It can also be reused and laundered when needed to maintain cleanliness.

Owners and operators of aircraft that require flooring protection will benefit from the surface protection systems use by ensuring that contaminates do not make it to the flooring beneath the surface protection system and therefore will maintain the surfaces integrity and value. The ability to easily deploy the surface protection system when needed, coupled with the easy storage of the surface protection system will make it appealing to a wide range of owners and operators of various aircraft models.

The surface protection system is manufactured using traditional sewing techniques and tooling. First matching pieces of top and bottom layer are cut to size. Next, the fasteners are sewn into their respective placement locations. The top and bottom layers are then laid upon each other inside out and sewn together on the sides and bottom as shown in FIG. 8 (830); leaving the top open. It is then turned inside out, and the topside stitch method is used to secure the sides and bottom together as shown in FIG. 8 (840). Finally, the top is tucked and sewn with the straps in place creating a finished product.

Accordingly, as described above, a surface protection system is provided that includes two or more textile materials that when combined create an effective barrier to protect the underlying flooring surfaces in the aircraft from contaminates. At top surface can be absorbent to prevent the runoff of liquids onto the surrounding surfaces and a bottom surface can be waterproof to prevent liquids from reaching the surfaces below. Additional advantages of the surface protection system include:
The ability to add an adjustable flap to fit varying aircraft models entryway location openings.
The ability to be rolled and secured using the integrated straps
The ability to be stored in a compact fashion once rolled.
The ability to be deployed quickly and easily in a manner which offers maximum protection for the flooring surfaces below.
The ability to be laundered using traditional methods to maintain its cleanliness and appearance.

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. I therefore claim as my invention all that comes within the scope and spirit of these claims.

We claim:

1. An aircraft carpet protection system comprising:
a main body, the main body comprising a first top layer and a first bottom layer, the first top layer comprising a first absorbent textile material and the first bottom layer comprising a first waterproof material, the top surface of the first top layer comprising a first fastening member; and
an extending member that comprises a second top layer and a second bottom layer, the second top layer comprising a second absorbent textile material and the second bottom layer comprising a second waterproof material, the top surface of the first top layer comprising a second fastening member,
wherein the first fastening member is configured to engage with the second fastening member.

2. The aircraft protection system of claim 1, wherein a length of the main body is between 108 and 230 inches.

3. The aircraft protection system of claim 1, wherein the first absorbent textile material is the same as the second absorbent textile material.

4. The aircraft protection system of claim 1, wherein the first waterproof material is the same as the second waterproof material.

5. The aircraft protection system of claim 1, wherein the first and second absorbent textile materials comprise a cotton canvas material.

6. The aircraft protection system of claim 1, wherein the first and second waterproof materials comprises a light-weight textured vinyl material.

7. The aircraft protection system of claim 1, wherein the first and second fastening members are configured to mate with one another to removably secure a bottom surface of the extending member to a top surface of the main body.

8. The aircraft protection system of claim 7, wherein the extending member is configured to be received on the main body at a plurality of different positions.

9. The aircraft protection system of claim 8, wherein the first and second fastening members comprise a hook and loop fastener system.

10. The aircraft protection system of claim 9, wherein the first fastening member extends along a first length of the main body and the second fastening member extends along as second length of the extending member, wherein the first length is between 1.5 and 3 greater than the second length.

11. The aircraft protection system of claim 1, further comprising at least one strap member configured to secure the main body of the aircraft protection system in a rolled position.

12. The aircraft protection system of claim 11, wherein the at least one strap member is fixed to the main body.
